(19) United States
(12) Patent Application Publication
(10) Pub. No.: US 2013/0028272 A1
(43) Pub. Date: Jan. 31, 2013

(54) COMMUNICATION APPARATUS, PACKETIZATION PERIOD CHANGE METHOD, AND PROGRAM

(71) Applicants: Naoki Tohda, Tokyo (JP); Masaki Umayabashi, Tokyo (JP)

(72) Inventors: Naoki Tohda, Tokyo (JP); Masaki Umayabashi, Tokyo (JP)

(73) Assignee: NEC Corporation, Tokyo (JP)

(21) Appl. No.: 13/553,763

(22) Filed: Jul. 19, 2012

(30) Foreign Application Priority Data
Jul. 27, 2011 (JP) 2011-164050

(51) Int. Cl. H04J 3/16

(52) U.S. Cl. 370/516

(57) ABSTRACT

To provide a communication apparatus and a packetization period change method that allow a packetization period/TDM period to change during a service of a TDM-PW system without affecting the service traffic, there is provided a communication apparatus that receives packetized data converted from TDM data, including a period information detection unit, a jitter buffer that stores the packetized data for a certain period of time, and a jitter buffer capacity control unit. The period information detection unit extracts packetization period information indicating a period to packetize TDM data contained in the received packetized data and acquires a TDM period to time-division multiplex the packetized data based on the packetization period information. The jitter buffer capacity control unit receives the acquired TDM period and controls a capacity of the jitter buffer in accordance with the TDM period.

### INCORPORATION BY REFERENCE

This application is based upon and claims the benefit of priority from Japanese patent application No. 2011-164050, filed on Jul. 27, 2011, the disclosure of which is incorporated herein in its entirety by reference.

### BACKGROUND OF THE INVENTION

1. Technical Field

The present invention relates to a communication apparatus of a TDM-PW (Time Division Multiplexing-Pseudo Wire) system and, particularly, to a technique to change a packetization period and a TDM period without stopping a service.

2. Background Art

In a system where an apparatus to convert TDM data into packets (at the transmitting end) and an apparatus to convert packets into TDM (at the receiving end) are connected with each other, it is necessary to perform an operation to change the packetization period at the transmitting end and an operation to change the TDM period at the receiving end from external control terminals. In the operation to change the packetization period, a packet loss can occur if the packetization period is changed during a service, and therefore the packetization period cannot be changed during a service.

Accordingly, in the TDM-PW system, it is typical to set the packetization period in the apparatus that performs packetization of TDM data at the transmitting end and the TDM period in the apparatus that performs TDM of packets at the receiving end before the start of a service and use them as fixed values.

As a related technique, regarding a system to multiplex packets, a communication apparatus that can communicate with a peripheral communication apparatus by multiplexing packets without a collision of packets even when the period to transmit packets is changed is disclosed in Japanese Unexamined Patent Application Publication No. 2008-227962. In this technique, transmission period information is inserted into a time slot as shown in FIG. 3 to thereby notify the transmission period from a communication apparatus at the transmitting end to a communication apparatus at the receiving end. In addition, as described in the summary of this technique, in the case of extending the transmission period, it is determined whether the use state of a transmission time slot in the transmission period is “RTC” (occurrence of a collision) or not, and, when none of the use states are “RTC”, the current transmission time slot is determined as the next transmission time slot without any change. Further, in the case of reducing the transmission period, when it is determined that none of the use states of the transmission time slot in the transmission period are “RTC” and a reverse time slot to the transmission time slot in the current transmission period is not used, the packet transmission period of is reduced to ½ without changing the current transmission time slot.

However, in the TDM-PW system, when the packetization period is changed during a service, if the range of changing the packetization period is large, a buffer error such as buffer underrun or buffer overrun can occur. Therefore, even if the timing to change the packetization period can be synchronized between the communication apparatus at the transmitting end and the communication apparatus the receiving end by notifying the packetization period from the communication apparatus at the transmitting end to the communication apparatus at the receiving end using the technique of notifying the transmission period information from the transmitting end to the receiving end, there arises a case where the occurrence of a buffer error such as buffer underrun or buffer overrun is unavoidable.

On the other hand, the value of the packetization period/TDM period generally has a directly proportional relationship with a delay and has a trade-off relationship with a band use efficiency. In other words, a delay decreases as the period becomes shorter, and a delay increases as the period becomes longer. Further, a band use efficiency decreases as the period becomes shorter because the overhead increases, and a band use efficiency increases as the period becomes longer.

In the case of using the packetization period/TDM period as fixed values with those relationships established, there is a possibility that it is not flexibly adaptable to changes in traffic such as not being able to satisfy the changed requirement for QoS (Quality of Service) (delay) of the accepted traffic or not being able to accept all lines when the number of connected lines increases.

### SUMMARY

An exemplary object of the invention is to allow the packetization period/TDM period to change during a service of a TDM-PW system without affecting the service traffic.

In a first exemplary aspect of the invention, a communication apparatus that receives packetized data converted from TDM data at least includes a period information detection unit, a jitter buffer that stores the packetized data for a certain period of time, and a jitter buffer capacity control unit. The period information detection unit extracts packetization period information indicating a period to packetize TDM data contained in received packetized data and acquires a TDM period to time-division multiplex packetized data based on the packetization period information. The jitter buffer capacity control unit receives the acquired TDM period and controls a capacity of the jitter buffer in accordance with the TDM period.

In a second exemplary aspect of the invention, a packetization period change method is a method for a communication apparatus that receives packetized data converted from TDM data, including extracting packetization period information indicating a period to packetize TDM data contained in received packetized data (packetization period information extraction step), acquiring a TDM period to time-division multiplex packetized data based on the packetization period information (packetization period information acquisition step), and controlling a capacity of a jitter buffer that stores the packetized data for a certain period of time in accordance with the acquired TDM period (jitter buffer capacity control step).

In a third exemplary aspect of the invention, a non-transitory computer-readable medium stores a program to implement a packetization period change method for a communication apparatus that receives packetized data converted from TDM data, the program causing a computer to execute processing of extracting packetization period information indicating a period to packetize TDM data contained in received packetized data, processing of acquiring a TDM period to time-division multiplex packetized data based on the packetization period information, and processing of controlling a capacity of a jitter buffer that stores the packetized data for a certain period of time in accordance with the acquired TDM period.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a view showing a configuration example of a communication apparatus according to a first exemplary embodiment of the invention;

FIG. 2A is a diagram showing a detailed configuration of a period information insertion unit and a period information detection unit according to the first exemplary embodiment of the invention;

FIG. 2B is a diagram showing a relationship among a period information detection unit, a jitter buffer capacity control unit, and a jitter buffer according to the first exemplary embodiment of the invention;

FIG. 2C is a diagram showing an example of a TDM period table;

FIG. 3 is a flowchart showing an example of an operation to notify packetization period information from a communication apparatus at the transmitting end to a communication apparatus at the receiving end;

FIG. 4 is a diagram to explain an operation of communication apparatus at the transmitting end and the receiving end at the time of changing a packetization period from 1 ms to 2 ms;

FIG. 5 is a diagram to explain a transfer method that transfers packetization period information using a Reserved part of Reserved bit Control Word in CESoPSN (RFC5086);

FIG. 6 is a diagram to explain a transfer method that transfers packetization period information using a Reserved part of Reserved bit Control Word in SAToP (RFC4553);

FIG. 7 is a diagram to explain a transfer method that transfers packetization period information using a Reserved part of Reserved bit Control Word in SONET/SDH CES (RFC4842);

FIG. 8 is a diagram to explain a transfer method that transfers packetization period information using a part of a payload;

FIG. 9 is a diagram to explain a transfer method that transfers packetization period information using a Reserved/non-used part (Payload Type area) of an RTP header;

FIG. 10 is a diagram to explain a transfer method that transfers packetization period information using a Reserved/non-used part (timestamp area) of an RTP header;

FIG. 11 is a diagram showing a frame format of SAToP [RFC4553]

FIG. 12 is a diagram showing a frame format of CESoPSN [RFC5086], and

FIG. 13 is a diagram showing a frame format of SONET/SDH [RFC4842].

### EXEMPLARY EMBODIMENT

Exemplary embodiments of the present invention will be described hereinafter with reference to the drawings. The following description and the attached drawings are appropriately shortened and simplified to clarify the explanation. In the drawings, the elements and their equivalents having the same configurations or functions will be denoted by the same reference symbols and redundant description will be omitted.

According to the present invention, a TDM-PW (Time Division Multiplexing-Pseudo Wire) system is configured to allow the packetization period and the TDM period to change without stopping a service. For example, when a communication apparatus at the transmitting end receives an instruction to change the packetization period to convert TDM data into packets from an external terminal, it inserts new packetization period information into a main signal and transmits the signal to a communication apparatus at the receiving end. The communication apparatus at the receiving end extracts the packetization period information from the received packet and then changes the TDM period to convert the packetized data into TDM and adjusts the jitter buffer capacity. Exemplary embodiments will be described hereinafter with reference to the drawings.

### First Exemplary Embodiment

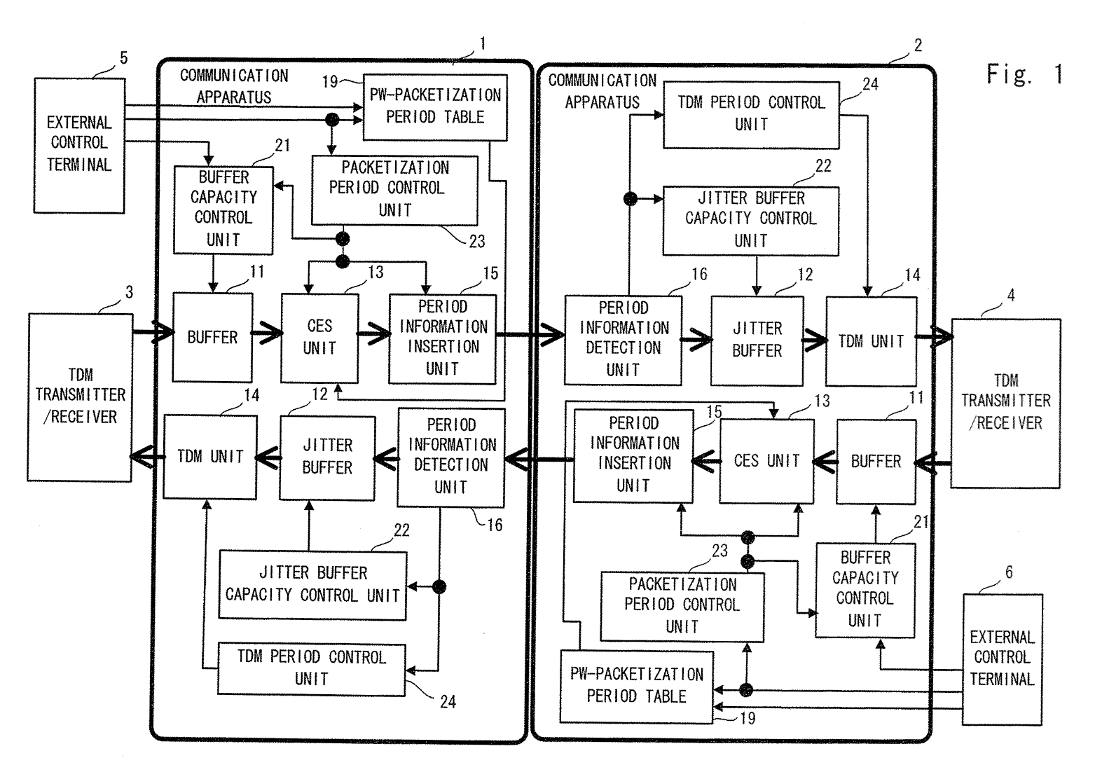

FIG. 1 is a view showing a configuration example of a communication apparatus according to a first exemplary embodiment of the invention. FIG. 1 shows the case where communication apparatus 1 and 2, one of which is at the transmitting end and the other is at the receiving end, have the same configuration.

The communication apparatus 1 and 2 include a buffer 11, a CES unit (CES circuit) 13, a period information insertion unit (packetization period information insertion circuit) 15, a PW-packetization period table 19, a buffer capacity control unit (buffer capacity control circuit) 21, a packetization period control unit (packetization period control circuit) 23, a period information detection unit (packetization period information detection circuit) 16, a jitter buffer 12, a TDM unit (TDM circuit) 14, a jitter buffer capacity control unit (jitter buffer capacity control circuit) 22, and a TDM period control unit (TDM period control circuit) 24.

Further, external control terminals 5 and 6 for making setting of the communication apparatus 1 and 2 are connected. In addition, TDM transmitter/receivers 3 and 4 are connected as TDM client devices to the communication apparatus 1 and 2, respectively.

The buffer 11 is a buffer that temporarily stores TDM data from the TDM transmitter/receiver 3 or 4.

The CES unit 13 is a circuit that acquires TDM data from the buffer 11, performs packetization at a given period, and inserts PW label information (PW label value) at the time of packetization.

The period information insertion unit 15 is a circuit that receives Ethernet (registered trademark) data (hereinafter, data received by the period information insertion unit 15 is referred to as “received data”), for example, from the CES unit 13, inserts packetization period information into the received data, and transmits it to the period information detection unit 16 of the opposite (other) communication apparatus.

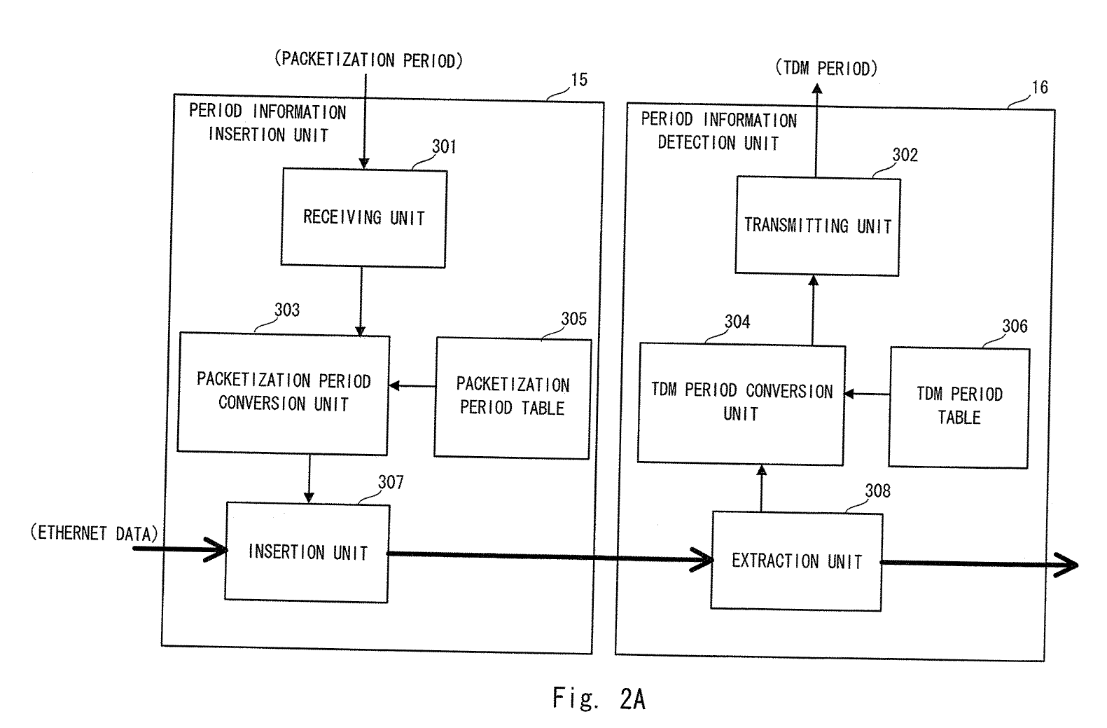

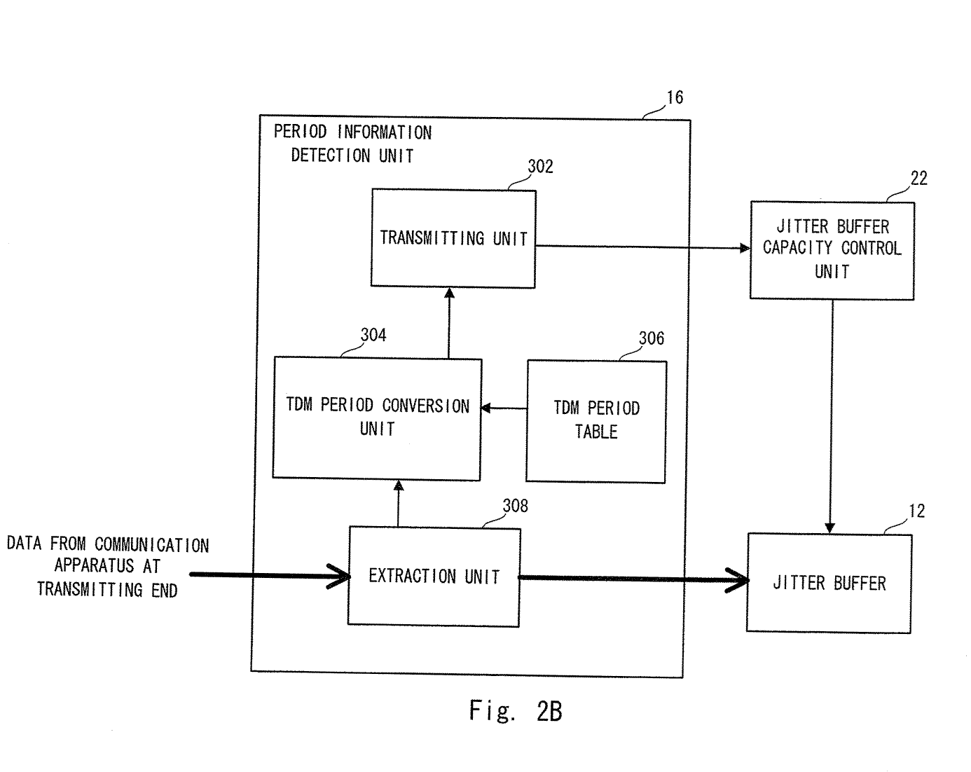

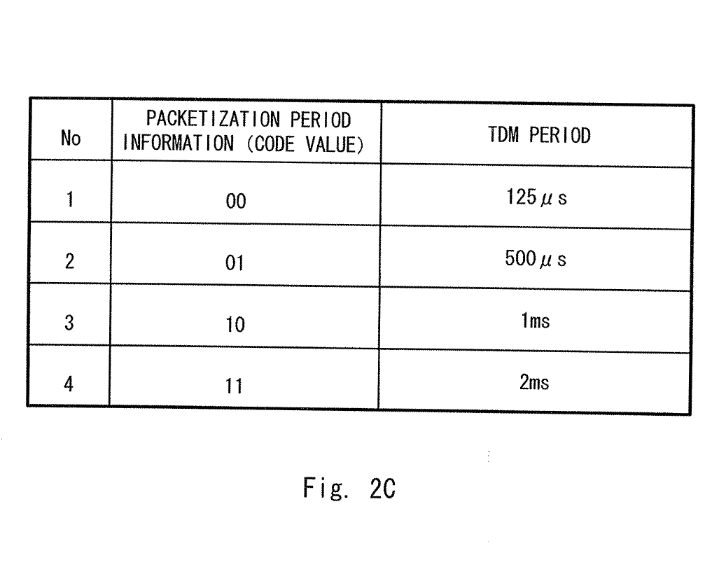

The packetization period information is information indicating the packetization period to packetize data, and a code value is used, for example. Further, the packetization period information is used by conversion into the TDM period which is used when converting the packetized data into the TDM data in the communication apparatus at the receiving end. The packetization period and the TDM period are substantially the same value. This is described later with reference to FIGS. 2A to 2C.

The PW-packetization period table 19 is an internal table to associate PW label information set by the external control terminal 5 or 6 and the packetization period information.

The buffer capacity control unit 21 is a circuit that controls the capacity of the buffer 11 on the basis of buffer capacity setting information from the external control terminal 5 or 6 and the packetization period information from the packetization period control unit 23.

The packetization period control unit 23 is a circuit that transmits packetization period setting information from the external control terminal 5 or 6 to the buffer capacity control unit 21, the CES unit 13 and the period information insertion unit 15.

The period information detection unit 16 is a circuit that receives the received data, reads the packetization period information, and transmits the information to the TDM period control unit 24 and the jitter buffer capacity control unit 22. Further, the period information detection unit 16 is a circuit that transmits the received data to the jitter buffer 12.

The jitter buffer 12 is a buffer that stores the received data for a given length of time.

The TDM unit 14 is a circuit that converts the received data into TDM at a given period and transmits the TDM data to the TDM transmitter/receiver 3 or 4.

The jitter buffer capacity control unit 22 is a circuit that controls the capacity of the jitter buffer 12 after receiving the packetization period information.

The TDM period control unit 24 is a circuit that controls the TDM period of the TDM unit 14 after receiving the packetization period information.

FIG. 2A shows a detailed configuration of the period information insertion unit 15 and the period information detection unit 16 according to the first exemplary embodiment of the invention.

The period information insertion unit 15 includes a receiving unit (packetization period information receiving unit) 301, a packetization period conversion unit (packetization period information-insertion data conversion circuit) 303, a packetization period table (packetization period setting information table) 305, and an insertion unit (packetization period information insertion unit) 307.

The period information detection unit 16 includes a transmitting unit (packetization period information transmitting unit) 302, a TDM period conversion unit (packetization period information-insertion data conversion circuit) 304, a TDM period table (TDM period setting information table) 306, and an extraction unit (packetization period information extraction unit) 308.

The receiving unit 301 is a circuit that receives the packetization period from the packetization period control unit 23.

The packetization period conversion unit 303 is a circuit that converts the packetization period into a code value to be written to a packet by reference to the packetization period table 305. The case of using the code value as an example of the packetization period information is described in this example.

The packetization period table 305 is a table to store setting of conversion rules between the packetization period and the code value to be written to a packet.

The insertion unit 307 is a circuit that inserts the code value to be written to a packet into the received data and transmits the received data to the period information detection unit 16.

The extraction unit 308 is a circuit that reads the code value indicating the packetization period from the received data and transmits the read code value to the TDM period conversion unit 304.

The TDM period conversion unit 304 is a circuit that converts the code value received from the extraction unit 308 into the TDM period (packetization period) by reference to the TDM period table 306 and transmits the TDM period to the transmitting unit 302.

The TDM period table 306 is a table to store setting of conversion rules between the code value indicating the packetization period inserted into the received data and the TDM period.

The transmitting unit 302 is a circuit that transmits the TDM period to the jitter buffer capacity control unit 22 and the TDM period control unit 24.

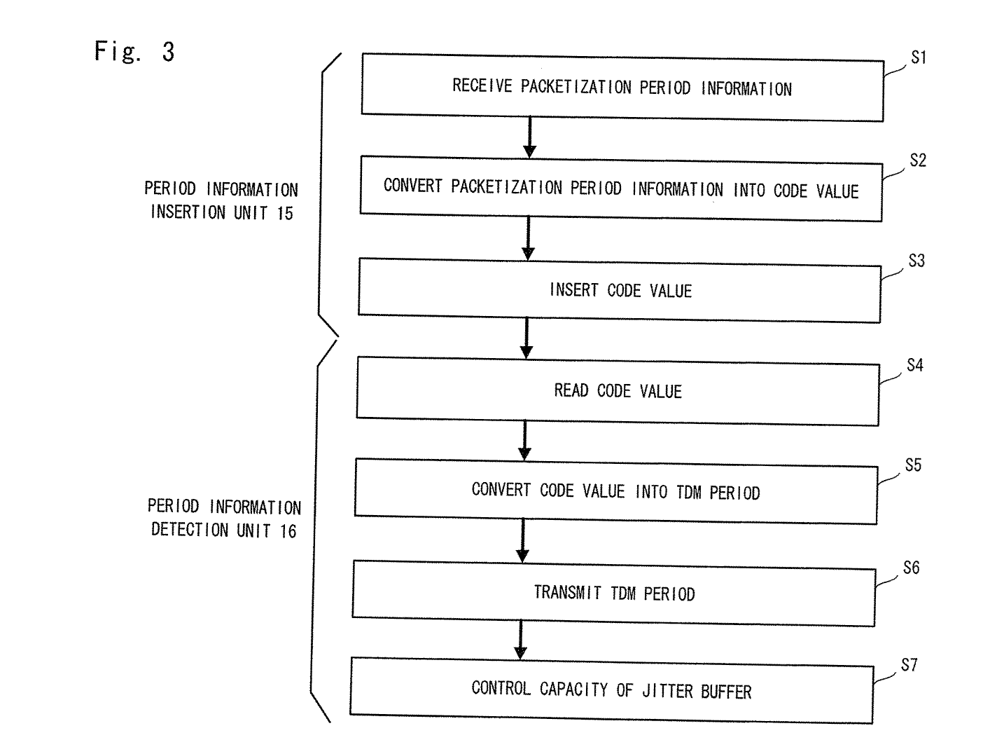

FIG. 2B is a diagram showing a relationship among the period information detection unit 16, the jitter buffer capacity control unit 22, and the jitter buffer 12 according to the first exemplary embodiment of the invention. The transmitting unit 302 transmits packetization period information (TDM period) to the jitter buffer capacity control unit 22. Further, FIG. 2C is a diagram showing an example of the TDM period table 306. The TDM period table 306 associates the packetization period information (code value) with the TDM period. Note that the packetization period table 305 can be configured by replacing the TDM period in the TDM period table 306 shown in FIG. 2C with the packetization period, and it associates the packetization period with the packetization period information (code value). FIGS. 2B and 2C are described with reference to FIG. 3.

Although the case where the CES unit 13, the period information insertion unit 15, the buffer capacity control unit 21, the packetization period control unit 23, the period information detection unit 16, the TDM unit 14, the jitter buffer capacity control unit 22 and the TDM period control unit 24 are configured by circuits (hardware) is described as an example in FIG. 1, it is not limited thereto. For example, they may be configured by software or a combination of circuits and software. Likewise, the receiving unit 301, the packetization period conversion unit 303, the insertion unit 307, the transmitting unit 302, the TDM period conversion unit 304 and the extraction unit 308 in FIGS. 2A and 2B are also not limited to be configured by circuits.

FIG. 3 is a flowchart showing an example of an operation to notify packetization period information from a communication apparatus at the transmitting end to a communication apparatus at the receiving end. The following description is based on the assumption that the communication apparatus 1 is at the transmitting end and the communication apparatus 2 is at the receiving end.

The receiving unit 301 of the period information insertion unit 15 receives an instruction to change the packetization period from the external control terminal 5 through the packetization period control unit 23 and thereby receives new packetization period information in Step S1.

After that, in Step S2, the packetization period conversion unit 303 converts the packetization period information received in Step S1 into a code value by reference to the packetization period table 305. The insertion unit 307 inserts the converted code value into a given part of a main signal packet in Step S3.

The main signal packet (received data) with the code value inserted is transmitted from the communication apparatus 1 at the transmitting end to the communication apparatus 2 at the receiving end.

Then, the extraction unit 308 of the period information detection unit 16 in the communication apparatus 2 at the receiving end reads the code value of the packetization period information from the received packet in Step S4.

The TDM period conversion unit 304 converts the code value into the TDM period by reference to the TDM period table 306 in Step S5. The transmitting unit 302 transmits the new TDM period to the TDM period control unit 24 and the jitter buffer capacity control unit 22 in Step S6.

The jitter buffer capacity control unit 22 controls the capacity of the jitter buffer 12 based on the received new TDM period in Step S7. The TDM period control unit 24 notifies the new TDM period to the TDM unit 14.

A specific operation example in the case where “01” is notified as the packetization period information (code value) shown in FIG. 2C, for example, to the communication apparatus 2 at the receiving end from the transmitting end is described hereinbelow.

The extraction unit 308 extracts the code value “01” from the received data received from the communication apparatus 1 at the transmitting end (S4). The TDM period conversion unit 304 receives the packetization period information “01” from the extraction unit 308 and converts the code value “01” into the TDM period “500 μs” by reference to the TDM period table 306 (S5). The transmitting unit 302 transmits the TDM period “500 μs” acquired by the TDM period conversion unit 304 to the jitter buffer capacity control unit 22 and the TDM period control unit 24 (S6). The jitter buffer capacity control unit 22 controls (changes) the jitter buffer 12 to the capacity in accordance with the TDM period “500 μs” (S7).

As described with reference to the flowchart of FIG. 3, by the configuration of FIG. 2A, the packetization period information is notified from the communication apparatus 1 at the transmitting end to the communication apparatus 2 at the receiving end. Then, as shown in FIG. 2B, the communication apparatus 2 at the receiving end controls the capacity of the jitter buffer 12 in its own apparatus based on the notified packetization period information (code value).

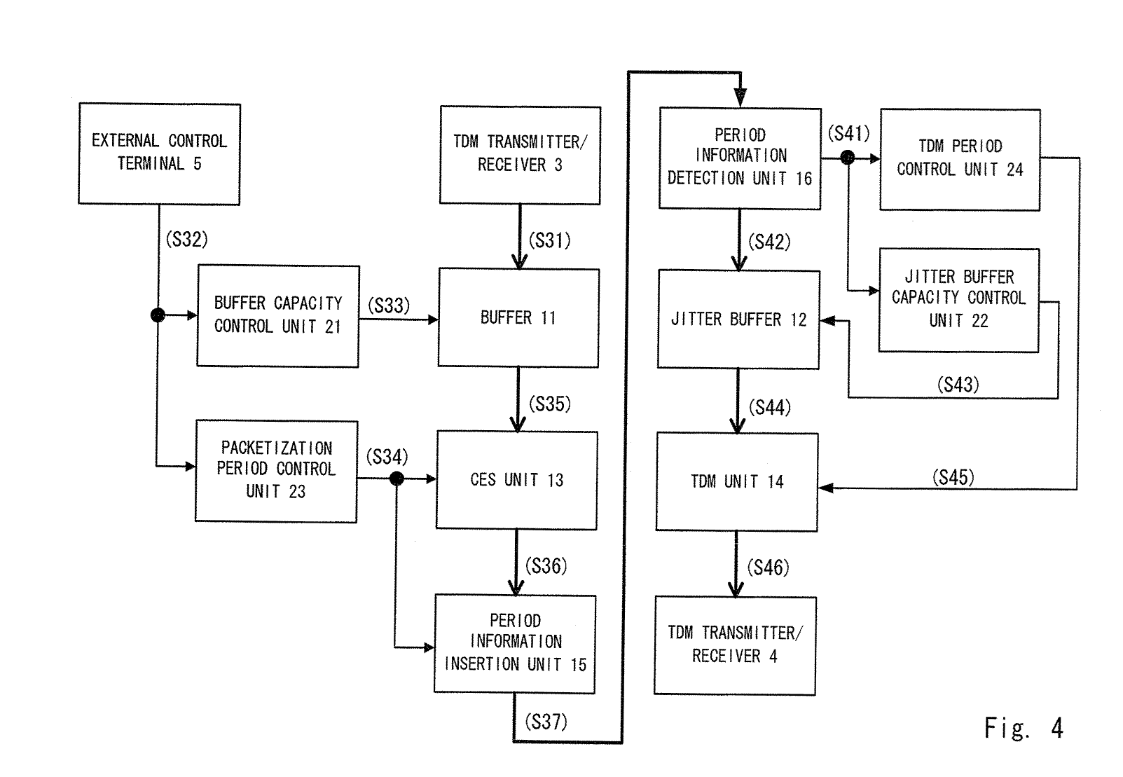

FIG. 4 is a diagram to explain an operation of communication apparatus at the transmitting end and the receiving end at the time of changing the packetization period from 1 ms to 2 ms. Note that the step numbers such as (S31) shown in FIG. 4 do not necessarily indicate the sequence in chronological order, and a plurality of arbitrary steps may be processed in parallel.

The following operation is performed in the communication apparatus 1 at the transmitting end.

The communication apparatus 1 temporarily stores the TDM data received from the TDM transmitter/receiver 3 into the buffer 11 (S31)

The external control terminal 5 makes setting to change the packetization period from 1 ms to 2 ms (S32).

The buffer capacity control unit 21 which has received an instruction to change the packetization period from the external control terminal 5 adjusts the buffer size so that buffer leakage does not occur (S33). In this example, the buffer capacity is increased to avoid overflow of the buffer 11.

In addition, the packetization period control unit 23 which has received an instruction to change the packetization period from the external control terminal 5 controls the CES unit 13 so as to change the packetization period from 1 ms to 2 ms (S34). In response to the instruction, the CES unit 13 changes the operation to read the received data from the buffer 11 every 1 ms (reading every 1 ms) to the operation to read the received data every 2 ms (reading every 2 ms) (S35). Further, the CES unit 13 changes the operation to convert the read received data into packets every 1 ms (packetization every 1 ms) to the operation to convert them into packets every 2 ms (packetization every 2 ms) (S36).

The packetization period control unit 23 transmits the packetization period to the period information insertion unit 15. At this time, the period information insertion unit 15 changes the packetization period to be inserted into a main signal from 1 ms to 2 ms (S37).

The following operation is performed in the communication apparatus 2 at the receiving end.

The period information detection unit 16 extracts the packetization period information that has been changed from 1 ms to 2 ms from the received data, changes the packetization period information (code value) into the TDM period and transmits the TDM period to the TDM period control unit 24 and the jitter buffer capacity control unit 22 (S41). At this time, the period information detection unit 16 temporarily stores the received data received from the communication apparatus 1 at the transmitting end into the jitter buffer 12 (S42).

The TDM period control unit 24 which have received the changed TDM period controls the TDM unit 14 to change the TDM period from 1 ms to 2 ms (S45).

Further, the buffer capacity control unit 21 which received the changed TDM period controls (adjusts) the buffer capacity so that a buffer error such as buffer underrun or buffer overrun does not occur in the jitter buffer 12 (S43). In the case where the packetization period is changed to 2 ms as in the operation example of FIG. 4, the capacity of the jitter buffer 12 is preferably ±2 ms or more, in other words, the buffer capacity to remedy a delay or early arrival of 2 ms of the received data in order to prevent a packet loss due to a jitter buffer underrun or overrun error. This is the range where a loss does not occur when an Ethernet (registered trademark) frame varies. For example, when an Ethernet (registered trademark) frame delays, a loss does not occur if the delay is 2 ms or less. On the other hand, a loss occurs if the delay is 2 ms or more. The same applies to the case where the frame arrives early. Although it is feasible to set a large jitter buffer capacity in advance, because the delay time is proportional to the jitter buffer capacity, it is preferred to control the jitter buffer capacity to be as small as possible.

The TDM unit 14 reads the packetized received data from the jitter buffer 12 (S44) and converts the packetized received data into TDM data using the changed TDM period (2 ms).

As in the above-described operation, because the communication apparatus 2 at the receiving end can detect the timing when the packetization period has been changed in the communication apparatus 1 at the transmitting end, and the communication apparatus 2 at the receiving end changes the TDM period by making automatic adjustment at the detected timing, the traffic is not affected.

As described above, the function to allow the packetization period to change from 1 ms to 2 ms even during a service is implemented by the above scheme.

A method of transferring packetization period information is described hereinbelow. In the exemplary embodiment of the invention, the packetization period information can be transferred by the following methods.

Transfer method (1): Transfer using a Reserved part of Reserved bit Control Word in a header

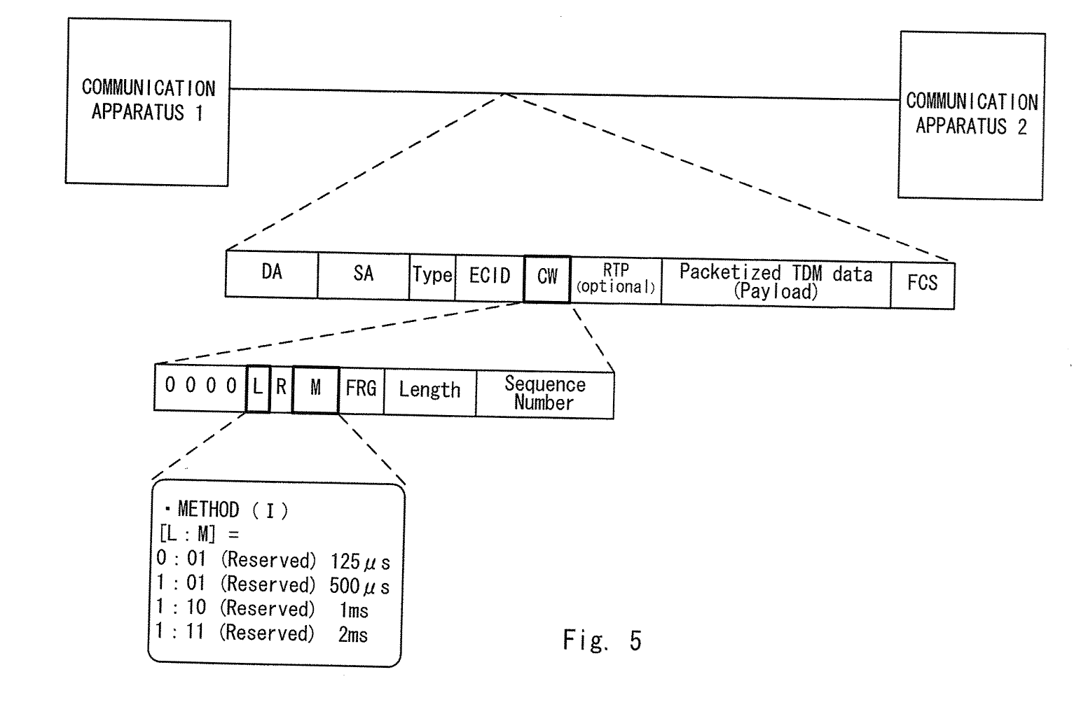

### (1-1): CESoPSN (RFC5086) (FIG. 5)

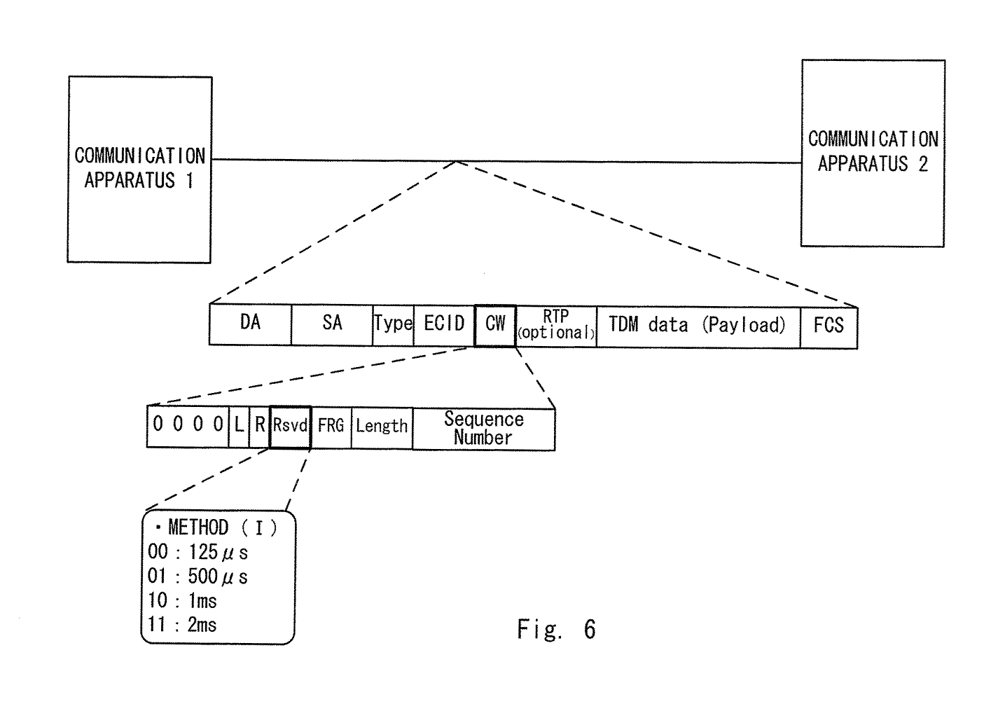

### (1-2): SAToP (RFC4553) (FIG. 6)

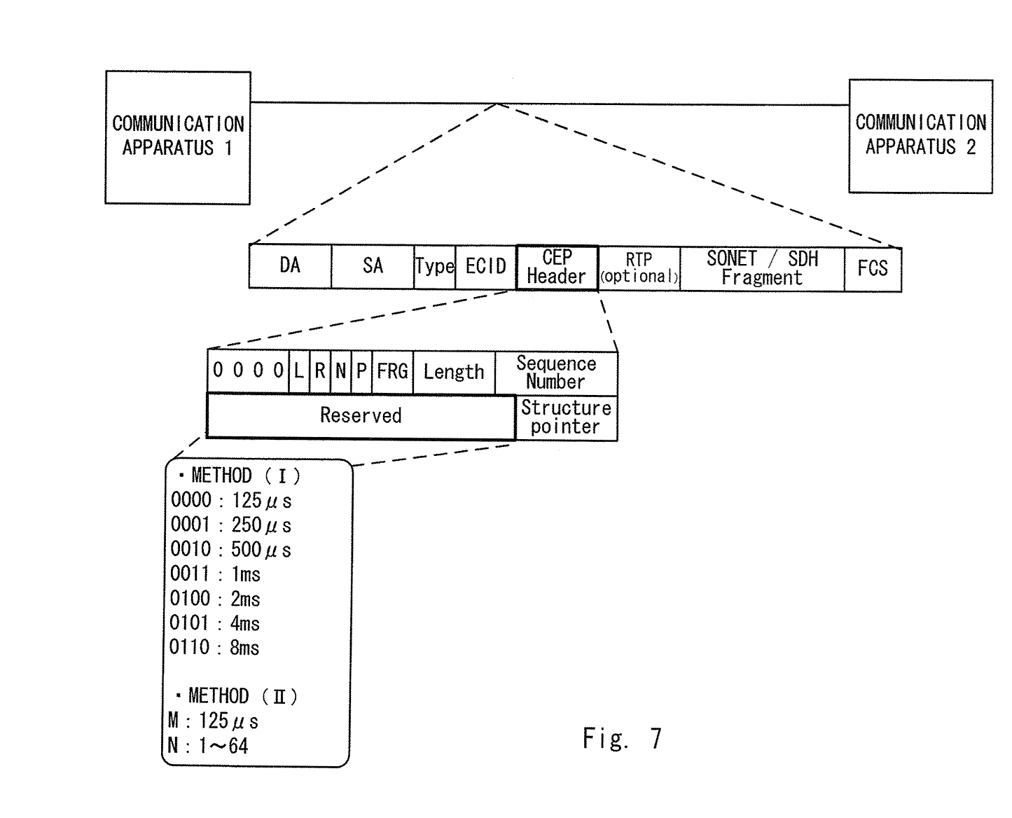

### (1-3): SONET/SDH CES (RFC4842) (FIG. 7)

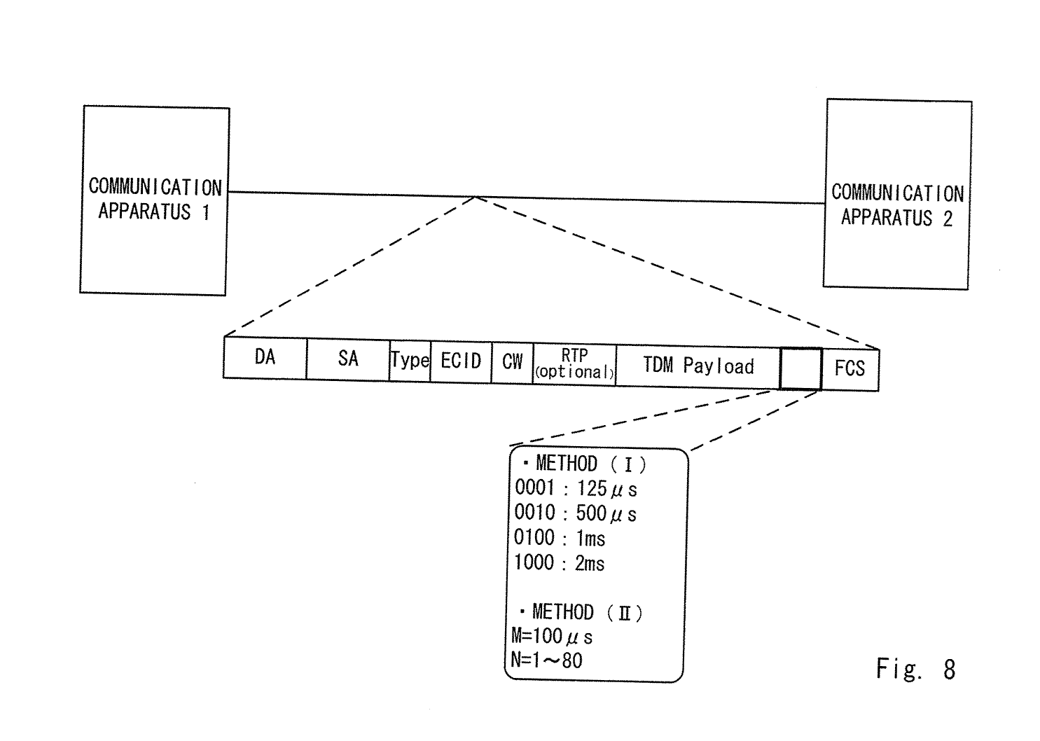

Transfer method (2): Transfer using a part of a payload (FIG. 8)

Transfer method (3): Transfer using a Reserved/non-used part of an RTP header

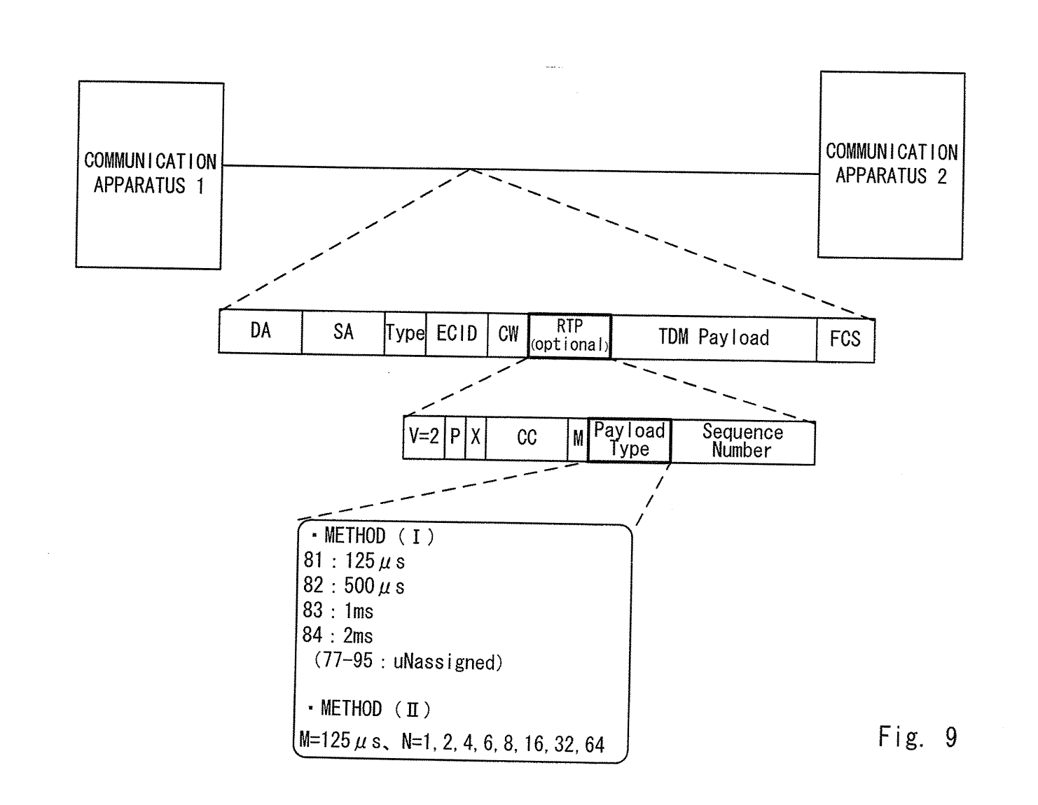

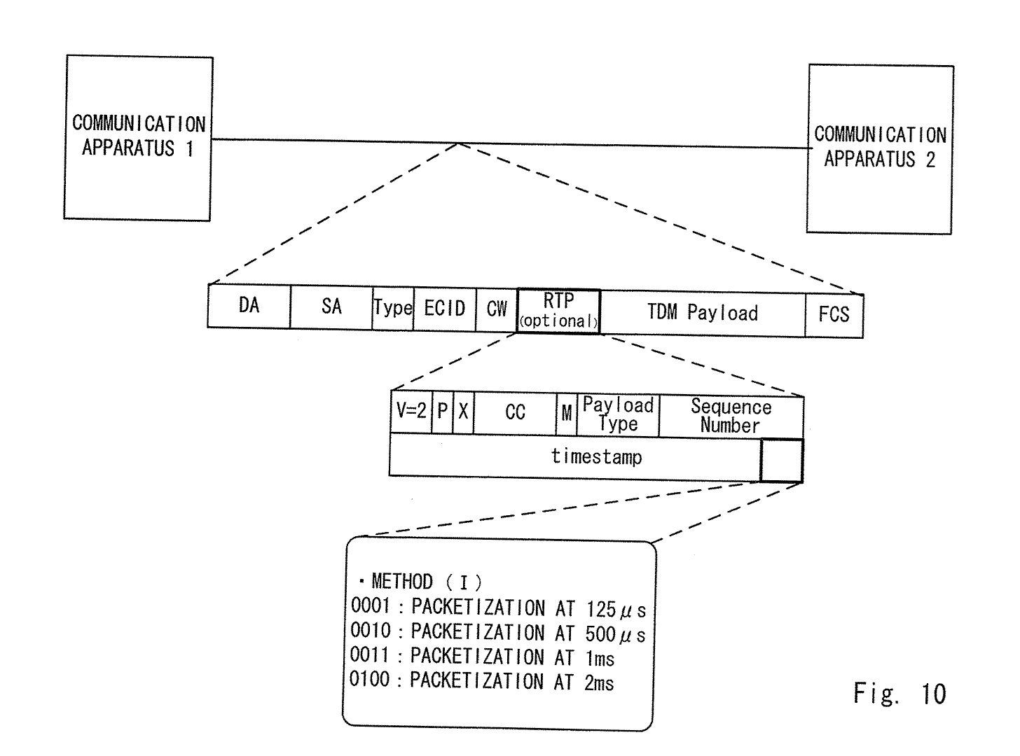

(3-1): Payload Type area (FIG. 9)
(3-2): timestamp area (FIG. 10)

Further, the following two types are proposed for the transfer value of the packetization period information.

Method (I): To select a packetization period value, a selection value is transferred.

Method (II): To perform packetization at N times a given time M, an N value is transferred (for example, when the packetization period is 1 ms, m=125 μs and N=4, and N=4 is transmitted).

In any of the methods (I) and (II), it is necessary to set conversion rules for the code value to be written to a packet in the packetization period table 305 and the TDM period table 306. Specifically, for the packetization period (TDM period) and the code value shown in FIGS. 5 to 10, the association to convert the packetization period into the code value is set in the packetization period table 305, and the association to convert the code value into the TDM period is set in the TDM period table 306.

The position to insert the packetization period information in each of the transfer methods is described hereinbelow.

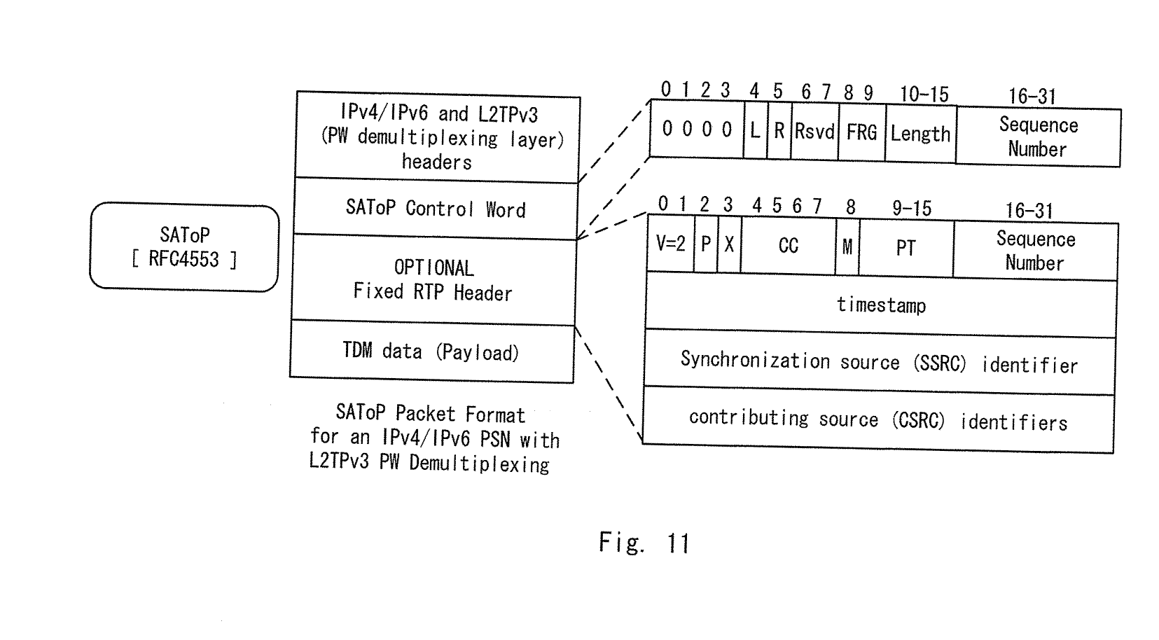

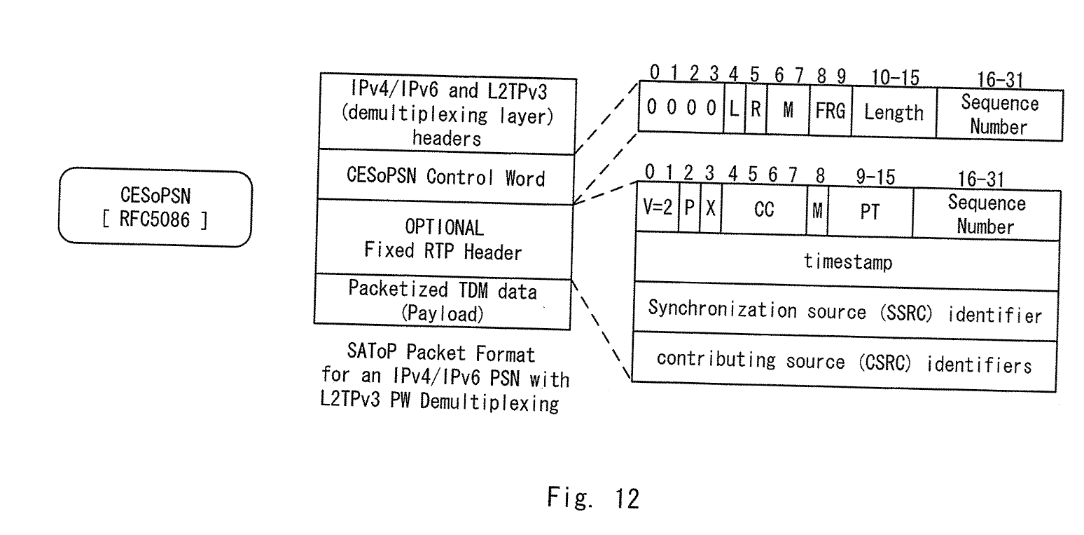

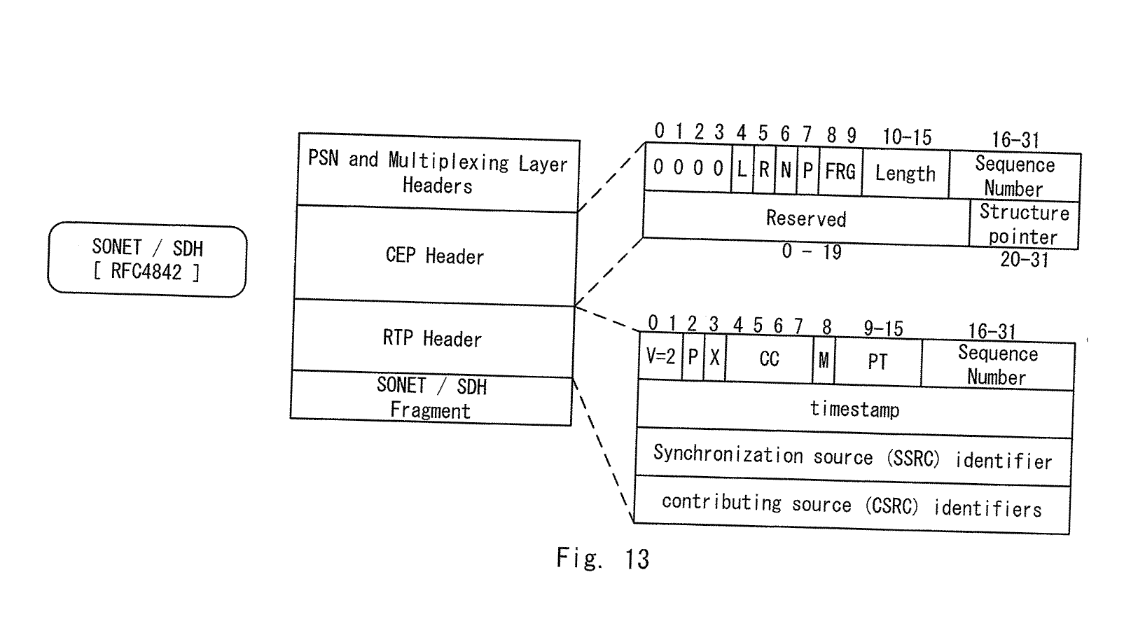

Note that the frame formats are shown in FIGS. 11 to 13. FIG. 11 shows a frame format of SAToP [RFC4553], FIG. 12 shows a frame format of CESoPSN [RFC5086], and FIG. 13 shows a frame format of SONET/SDH [RFC4842].

### Transfer Method (1-1)

FIG. 5 is a diagram illustrating the transfer method (1-1).

This is a transfer method that employs CES (Circuit Emulation Service) using CESoPSN (RFC5086) (Structure-Aware Time Division Multiplexed (TDM) Circuit Emulation Service over Packet Switched Network), and it is a method utilizing the Reserved pattern among combinations of L bit and M bit of CW (Control Word) in the header given at the time of CES.

Because the L bit and M bit are values referred to in a receiver, this method is used only for the case of changing a packetization period, and a value conforming to RFC5086 is used in other cases.

The method (I) is applicable to the transfer method (1-1). The definition is as follows, for example.

Method (I)

### L:M=0:01 (Reserved) . . . 125 μs

1:01 (Reserved) . . . 500 μs

1:10 (Reserved) . . . 1 ms

### 1:11 (Reserved) . . . 2 ms

### Transfer Method (1-2)

FIG. 6 is a diagram illustrating the transfer method (1-2).

This is a transfer method that employs CES using SAToP (RFC4553) (Structure-Agnostic Time Division Multiplexing (TDM) over Packet), and it is a method utilizing a Reserved part of CW in the header given at the time of CES.

The method (I) is applicable to the transfer method (1-2).

The definition is as follows, for example.

Method (I)

00: 125 μs

01: 500 μs

10: 1 ms

11: 2 ms

### Transfer Method (1-3)

FIG. 7 is a diagram illustrating the transfer method (1-3).

This is a transfer method that employs CES (RFC4842) on SONET/SDH (Synchronous Optical NETwork/Synchronous Digital Hierarchy), and it is a method utilizing a Reserved part of CEP (Circuit Emulation over Packet) Header in the header given at the time of CES.

The methods (I) and (II) are applicable to the transfer method (1-3).

The definition is as follows, for example.

Method (I)

0000: 125 μs

0001: 250 μs

0010: 500 μs

0011: 1 ms

0100: 2 ms

0101: 4 ms

0110: 8 ms

Method (II)

M=125 μs, N=1 to 64

### Transfer Method (2)

FIG. 8 is a diagram illustrating the transfer method (2).

This is a transfer method that inserts the packetization period information into a payload, and it is a method of inserting the packetization period information at the end of the received data (at the last part of week signal data of the payload).

The methods (I) and (II) are applicable to the transfer method (2).

The definition is as follows, for example.

Method (I)

0001: 125 μs

0010: 500 μs

0100: 1 ms

1000: 2 ms

Method (II)

M=100 μs, N=1 to 80

### Transfer Method (3-1)

FIG. 9 is a diagram illustrating the transfer method (3-1).

This is a transfer method that utilizes a Payload Type part in the case of inserting the RTP (Real-time Transport Protocol) header at the time of CES, and it is a method of transferring the packetization period using unassigned numbers of Payload Type.

Because 77 to 95 of Payload Type are unassigned, this part is used.

The methods (I) and (II) are applicable to the transfer method (3-1).

The definition is as follows, for example.

Method (I)

1010000 (80): 125 μs

1010001 (81): 500 μs

1010010 (82): 1 ms

1010011 (83): 2 ms

Method (II)

M=125 μs, N=1, 2, 4, 6, 8, 16, 32, 64

### Transfer Method (3-2)

FIG. 10 is a diagram illustrating the transfer method (3-2).

This is a transfer method that utilizes a timestamp part in the case of inserting an RTP header at the time of CES, and it is a method of utilizing lower bits of the timestamp for the transfer of the packetization period information.

The method (I) is applicable to the transfer method (3-2).

The definition is as follows, for example.

Method (I)

0001: 125 μs

0010: 500 μs

0100: 1 ms

1000: 2 ms

### Second Exemplary Embodiment

Although the operation that the period information detection unit 16 receives the packetization period information and transmits the information to the jitter buffer capacity control unit 22 and the TDM period control unit 24 is described in the first exemplary embodiment, the operation may be as follows. For example, in the case where the period information detection unit 16 stores the current TDM period or is able to acquire the current TDM period stored in a storage area of its own device, the period information detection unit 16 may transmit the newly acquired TDM period to the jitter buffer capacity control unit 22 and the TDM period control unit 24 when the newly detected TDM period is different from the current TDM period.

Further, information as to whether the packetization period has been changed or not may be contained in the packetization period information to be inserted into a main signal. For example, information indicating a change in the packetization period may be contained in the code value.

Further, the jitter buffer capacity control unit 22 may adjust the capacity according to the notified value of the TDM period. For example, the jitter buffer capacity control unit 22 may adjust the capacity of the jitter buffer 12 according to the value of the TDM period by using a predetermined calculation formula or the like. Alternatively, the jitter buffer capacity control unit 22 may store a capacity table to associate the TDM period with an appropriate capacity of the jitter buffer 12 and adjust the capacity of the jitter buffer 12 by reference to the capacity table when the TDM period is notified.

### Other Exemplary Embodiments

Although the case where the elements shown in FIGS. 1, 2A and 2B such as the period information detection unit 16 and the jitter buffer capacity control unit 22, for example, are implemented by circuits is described in each of the above exemplary embodiments, they may be implemented using a program. The program is loaded to a memory in a computer and executed under control of a CPU (Central Processing Unit).

The program is a program to implement a packetization period change method of a communication apparatus that receives the packetized data converted from TDM data, and it causes a computer to at least execute the following processing: (a) processing of extracting packetization period information indicating a period to packetize the TDM data contained in the received packetized data (packetization period information extraction processing), (b) processing of acquiring a TDM period to convert the packetized data into TDM on the basis of the packetization period information (packetization period information acquisition processing), and (c) processing of controlling the capacity of a jitter buffer that stores the packetized data for a given length of time in accordance with the acquired TDM period (jitter buffer capacity control processing). The packetization period information extraction processing and the packetization period information acquisition processing are to perform the processing implemented by the period information detection unit 16, and the jitter buffer capacity control processing is to perform the processing implemented by the jitter buffer capacity control unit 22.

Further, the program may be recorded on a computer-readable recording medium and provided. The program can be stored and provided to a computer using any type of non-transitory computer readable medium. The non-transitory computer readable medium includes any type of tangible storage medium. Examples of the non-transitory computer readable medium include magnetic storage media (such as floppy disks, magnetic tapes, hard disk drives, etc.), optical magnetic storage media (e.g. magneto-optical disks), CD-ROM (Read Only Memory), CD-R, CD-R/W, and semiconductor memories (such as mask ROM, PROM (Programmable ROM), EPROM (Erasable PROM), flash ROM, RAM (Random Access Memory), etc.). The program may be provided to a computer using any type of transitory computer readable medium. Examples of the transitory computer readable medium include electric signals, optical signals, and electromagnetic waves. The transitory computer readable medium can provide the program to a computer via a wired communication line such as an electric wire or optical fiber or a wireless communication line.

As described in each of the above exemplary embodiments, in FIG. 1, when the period information insertion unit 15 in the communication apparatus at the transmitting end receives an instruction to change the packetization period, it inserts new packetization period information into a main signal and transmits the signal to the communication apparatus at the receiving end. The period information detection unit 16 in the communication apparatus at the receiving end extracts the packetization period information from the received packet and then changes the TDM period and adjusts the jitter buffer capacity. By such control, it is possible to change the packetization period without stopping a service and prevent a packet loss.

Stated differently, by inserting the packetization period information into data transmitted from the communication apparatus at the transmitting end and transmitting it to the communication apparatus at the receiving end, the communication apparatus at the receiving end can detect the timing to change the packetization period. Further, the communication apparatus at the receiving end controls the jitter buffer, triggered by the timing when the packetization period information is detected. It is thereby possible to prevent an error in the buffer. Furthermore, by making control of the jitter buffer, it is possible to suppress the data delay time. In this manner, the communication apparatus that adopts this method can change the packetization period even during a service.

As described above, according to the exemplary embodiments of the present invention, it is possible to change the packetization period without the occurrence of a packet loss even when an operation of changing the packetization period is performed during a service.

While the invention has been particularly shown and described with reference to exemplary embodiments thereof, the invention is not limited to these exemplary embodiments. It will be understood by those of ordinary skill in the art that various changes in form and details may be made therein without departing from the spirit and scope of the present invention as defined by the claims.

The whole or part of the exemplary embodiments disclosed above can be described as, but not limited to, the following supplementary notes.

### (Supplementary Note 1)

A communication apparatus that receives packetized data converted from TDM data, including:

a period information detection unit that extracts packetization period information indicating a period to packetize TDM data contained in received data and acquires a TDM period to time-division multiplex packetized data based on the packetization period information;

a jitter buffer that stores the packetized data for a certain period of time; and

a jitter buffer capacity control unit that receives the acquired TDM period and controls a capacity of the jitter buffer in accordance with the TDM period.

### (Supplementary Note 2)

The communication apparatus according to Supplementary note 1, wherein the period information detection unit includes:

a TDM period table that stores the packetization period information and the TDM period in association with each other;

an extraction unit that extracts the packetization period information contained in the received packetized data; and

a conversion unit that acquires the TDM period associated with the extracted packetization period information by reference to the TDM period table.

### (Supplementary Note 3)

The communication apparatus according to Supplementary note 1 or 2, wherein the jitter buffer capacity control unit sets the capacity within a predetermined range with respect to the TDM period.

### (Supplementary Note 4)

The communication apparatus according to any one of Supplementary notes 1 to 3, wherein the jitter buffer capacity control unit controls the capacity of the jitter buffer to increase when the TDM period becomes longer and to decrease when the TDM period becomes shorter.

### (Supplementary Note 5)

The communication apparatus according to any one of Supplementary notes 1 to 4, wherein the packetization period information is inserted into a Reserved bit part of the packetized data.

### (Supplementary Note 6)

The communication apparatus according to any one of Supplementary notes 1 to 4, wherein the packetization period information is inserted into a payload part of the packetized data.

### (Supplementary Note 7)

The communication apparatus according to any one of Supplementary notes 1 to 4, wherein the packetization period information is inserted into an unassigned part of Payload Type in an RTP header of the packetized data.

### (Supplementary Note 8)

The communication apparatus according to any one of Supplementary notes 1 to 4, wherein the packetization period information is inserted into a timestamp part in an RTP header of the packetized data.

### (Supplementary Note 9)

A packetization period change method for a communication apparatus that receives packetized data converted from TDM data, including:

extracting packetization period information indicating a period to packetize TDM data contained in received packetized data;

acquiring a TDM period to time-division multiplex packetized data based on the packetization period information; and

controlling a capacity of a jitter buffer that stores the packetized data for a certain period of time in accordance with the acquired TDM period.

### (Supplementary Note 10)

A program to implement a packetization period change method for a communication apparatus that receives packetized data converted from TDM data, the program causing a computer to execute:

processing of extracting packetization period information indicating a period to packetize TDM data contained in received packetized data;

processing of acquiring a TDM period to time-division multiplex packetized data based on the packetization period information; and

processing of controlling a capacity of a jitter buffer that stores the packetized data for a certain period of time in accordance with the acquired TDM period.

### (Supplementary Note 11)

A communication system to transmit and receive packetized data converted from TDM data, including:

a communication apparatus at a transmitting end that generates packetized data converted from TDM data using packetization period information indicating a period to packetize TDM data, inserts the packetization period information into the packetized data and transmits the packetized data to a communication apparatus at a receiving end; and

a communication apparatus at a receiving end including:
a period information detection unit that extracts packetization period information indicating a period to packetize TDM data contained in received packetized data and acquires a TDM period to time-division multiplex packetized data based on the packetization period information;
a jitter buffer that stores the packetized data for a certain period of time; and
a jitter buffer capacity control unit that receives the acquired TDM period and controls a capacity of the jitter buffer in accordance with the TDM period.

### (Supplementary Note 12)

A packetization period change method for a communication system to transmit and receive packetized data converted from TDM data, including:

in a communication apparatus at a transmitting end,

generating packetized data converted from TDM data using packetization period information indicating a period to packetize TDM data, inserting the packetization period information into the packetized data, and transmitting the packetized data to a communication apparatus at a receiving end;

in a communication apparatus at a receiving end,

extracting packetization period information indicating a period to packetize TDM data contained in received packetized data;

acquiring a TDM period to time-division multiplex packetized data based on the packetization period information; and

controlling a capacity of a jitter buffer that stores the packetized data for a certain period of time in accordance with the acquired TDM period.

According to the exemplary embodiments of the invention, it is possible to provide a communication apparatus and a packetization period change method that allow the packetization period/TDM period to change during a service of a TDM-PW system without affecting the service traffic.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication apparatus that receives packetized data converted from TDM (Time Division Multiplexing) data, comprising:
a period information detection unit that extracts packetization period information indicating a period to packetize TDM data contained in received data and acquires a TDM period to time-division multiplex packetized data based on the packetization period information;
a jitter buffer that stores the packetized data for a certain period of time; and
a jitter buffer capacity control unit that receives the acquired TDM period and controls a capacity of the jitter buffer in accordance with the TDM period.

2. The communication apparatus according to claim 1, wherein the period information detection unit includes:
a TDM period table that stores the packetization period information and the TDM period in association with each other;
an extraction unit that extracts the packetization period information contained in the received packetized data; and
a conversion unit that acquires the TDM period associated with the extracted packetization period information by reference to the TDM period table.

3. The communication apparatus according to claim 1, wherein the jitter buffer capacity control unit sets the capacity within a predetermined range with respect to the TDM period.

4. The communication apparatus according to claim 2, wherein the jitter buffer capacity control unit sets the capacity within a predetermined range with respect to the TDM period.

5. The communication apparatus according to claim 1, wherein the jitter buffer capacity control unit controls the capacity of the jitter buffer to increase when the TDM period becomes longer and to decrease when the TDM period becomes shorter.

6. The communication apparatus according to claim 2, wherein the jitter buffer capacity control unit controls the capacity of the jitter buffer to increase when the TDM period becomes longer and to decrease when the TDM period becomes shorter.

7. The communication apparatus according to claim 3, wherein the jitter buffer capacity control unit controls the capacity of the jitter buffer to increase when the TDM period becomes longer and to decrease when the TDM period becomes shorter.

8. The communication apparatus according to claim 4, wherein the jitter buffer capacity control unit controls the capacity of the jitter buffer to increase when the TDM period becomes longer and to decrease when the TDM period becomes shorter.

9. The communication apparatus according to claim 1, wherein the packetization period information is inserted into a Reserved bit part of the packetized data.

10. The communication apparatus according to claim 2, wherein the packetization period information is inserted into a Reserved bit part of the packetized data.

11. The communication apparatus according to claim 1, wherein the packetization period information is inserted into a payload part of the packetized data.

12. The communication apparatus according to claim 2, wherein the packetization period information is inserted into a payload part of the packetized data.

13. The communication apparatus according to claim 1, wherein the packetization period information is inserted into an unassigned part of Payload Type in an RTP header of the packetized data.

14. The communication apparatus according to claim 2, wherein the packetization period information is inserted into an unassigned part of Payload Type in an RTP header of the packetized data.

15. The communication apparatus according to claim 1, wherein the packetization period information is inserted into a timestamp part in an RTP header of the packetized data.

16. The communication apparatus according to claim 2, wherein the packetization period information is inserted into a timestamp part in an RTP header of the packetized data.

17. A packetization period change method for a communication apparatus that receives packetized data converted from TDM data, comprising:
extracting packetization period information indicating a period to packetize TDM data contained in received packetized data;
acquiring a TDM period to time-division multiplex packetized data based on the packetization period information; and
controlling a capacity of a jitter buffer that stores the packetized data for a certain period of time in accordance with the acquired TDM period.

18. A non-transitory computer-readable medium storing a program to implement a packetization period change method for a communication apparatus that receives packetized data converted from TDM data, the program causing a computer to execute:
processing of extracting packetization period information indicating a period to packetize TDM data contained in received packetized data;
processing of acquiring a TDM period to time-division multiplex packetized data based on the packetization period information; and processing of controlling a capacity of a jitter buffer that stores the packetized data for a certain period of time in accordance with the acquired TDM period.
